(19) United States
(12) Patent Application Publication
(10) Pub. No.: US 2005/0091790 A1
(43) Pub. Date: May 5, 2005

(54) Wedge with push rod and handle

(76) Inventor: Thomas Joseph Mazzone, Auburn, AL (US)

Correspondence Address: Thomas J. Mazzone, 2238 Riverwood Dr., Auburn, AL, 36830, US

(21) Appl. No.: 10/700,269

(22) Filed: Nov. 4, 2003

(51) Int. Cl. E05F 5/02

(52) U.S. Cl. 16/82

(57) ABSTRACT

A wedge having a multiple number of sides to fit between a car door and the car body when the car door is opened to prevent the door from attempting to close through the force of gravity when the automobile is parked on an incline such as a street or driveway or hill. The wedge fits between the door hinge members in such a manner as to prevent the hinge from returning to the closed position until the wedge is pulled out of the hinge members. The handle has a hook at one end like that of a cane for insertion and retraction, and a push rod to push the door open from a seated position after it has been manually opened. The wedge ia attached to the handle at the opposite side of its forward surface, and is adapted to fit specific vehicles.

### BACKGROUND OF THE INVENTION 1. Field of the Invention

This invention relates to the application of wedges for the purpose of acting as a stop, acting as a release mechanism in motors, brakes, and other actuating devices having rotating, oscillating, or sliding parts found in railroad trains, trucks, cars and many other types of transportation. The purpose of this invention is to keep the door of an automobile open when a vehicle is stopped and parked on an incline in which the door has a tendency to close as a person attempts to exit the vehicle.

2. Description of the Prior Art

References Cited

U.S. Pat. Nos.

| | | | |
|---|---|---|---|
| 1,877,263 | September 1932 | Beauchamp | 292/342X |
| 3,989,291 | November 1976 | Hucknall | 292/262 |
| 4,042,265 | Aug. 16, 1977 | Chezem | 292/268/298 |
| 4,501,444 | February 1985 | Dominguez | 343,207,277 |
| 2,122,312 | June 1938 | Cassion | 292/342 |
| 5,421,124 | June 1995 | Zuccaro | 296/207 |
| 4,936,621 | June 1990 | Shimoda | 296/207X |
| 5,468,032 | November 1995 | Hebert Et Al. | 292/288 |
| 4,230,353 | October 1980 | Bjorgum | 292/343 |
| 5,711,560 | January 1998 | Gilbertson | 292/343 |
| 5,011,203 | April 1991 | Tackett | 292/343 |
| 6,574,833B1 | October 2003 | Tomaiuolo | 16/422 |
| 6,340,189B1 | January 2002 | Pordy | 296/1.1 |

The disclosures of the prior art are unique but functionally dissimilar than the purpose of this invention.

This invention is simple in construction, easy to make and serves a human need. Thomas J. Mazzone, the petitioner, is the sole inventor of this disclosure, and is not aware of any other patents in conflict with this, or proposed use.

### SUMMARY OF THE INVENTION

This invention has been initiated by experiencing the difficulty of exiting from a car when it is parked on a incline. The car door will not remain open, making it very hard to get out of the car. The problems takes on more difficulty if a person is handicapped. Therefore this invention is a solution to this problem by the use of a wedge with a push rod and a handle that can be inserted into the cervasse of the door hinge.

### BRIEF DISCRIPTION OF THE DRAWINGS

There are four basic views of this invention: A top view showing the structure of the wedge assembly, a view of the double eyelet coupling, a view of the assembly with the rod and handle as one integrated part, and a view illustrating the insertion of the wedge assembly into the mechanism of the hinge to prevent the door from closing when parked on an incline such as a driveway.

### DETAILED DISCRIPTION OF THE INVENTION

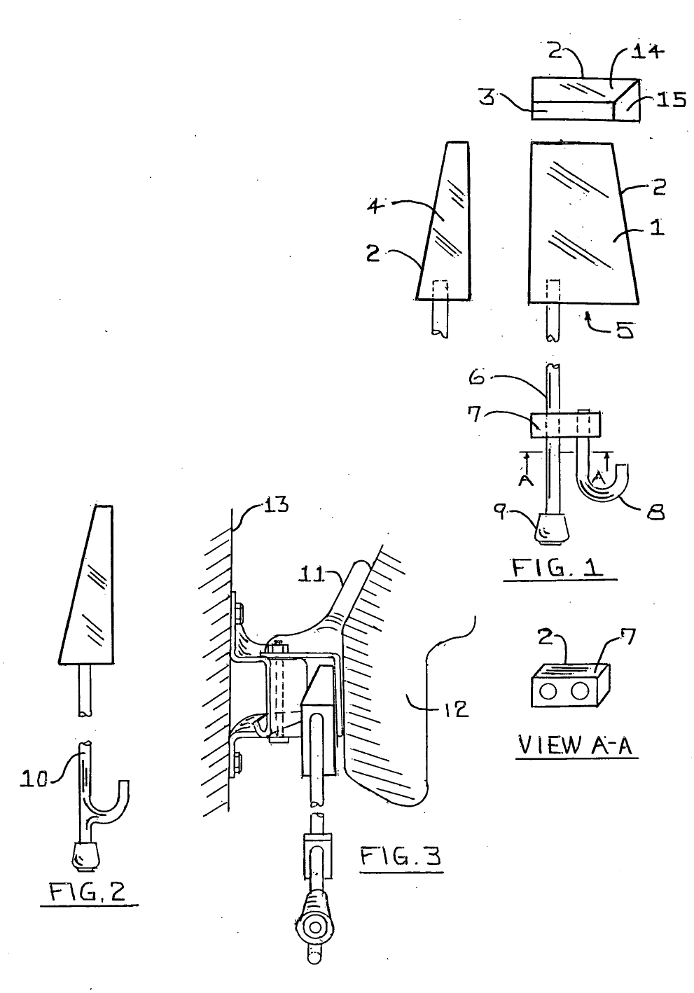

Initially, reference will be made to FIG. 1 since it is a plan view of the wedge with rod and handle assembly showing the top, front, side view of the wedge with the push rod and handle arranagement. The top view of the wedge, member 1, illustrates its geometric form with four (4) perpendicular sides and two (2) inclined sides. The front tip, side 3 and the rear side 5 are parallel to each other and side 4 is perpendicular to sides 3 and 5. All the surfaces of wedge member 1 are coated with a thick rubber like material that is referred to as member 2. The coupling with the double eyelet is referred to as member 7 and is also coated with the same material referred to as member 2.

Member 6 is a rod shown attached to the said wedge with a furniture cup attached to the end. The rod, member 6, passes through one eyelet of the coupling, member 7, and the second eyelet holds the hook (handle), member 8, in a firm position relative to the said rod. View A-A of the coupling illustrates the geometry of element. FIG. 2 depicts the rod, member 6, and the handle, member 8, constructed as one unit with the furniture cup, member 9, connected to the end of the rod as previously described, thereby, eliminating the need for a coupler. FIG. 3 illustrates the hinge connected to the car door 13 and the car body 12 with the door in the open position, and the said wedge inserted into the cervasse of the hinge 11, thereby preventing the door from closing.

1. A geometric object having multiple number of sides with inclinations and parallelisms relative to each other to produce a wedge that will hold an automobile door in the open position.
The surface of the tip and the opposite rear side are parallel, with the adjacent surfaces inclined at angles to their respective opposing sides that are perpendicular to each other.
The said wedge having a recessed hole in the rear side for attaching it to a rod.
A rod extending in a distal direction from the afore said tip, terminating with an attached furniture cup at the end of the rod.

2. The wedge of claim 1. with the said rod connected thereto, passing through a coupling with a double eyelet, and terminating with an attached furniture cup at the end of the rod.
A second rod with a hook at one end passes through and is attached to the second eyelet in a distal direction from the tip of the said wedge.

3. The wedge of claim 1. having the said rod with a furniture cup attached to it, with the said push rod and handle integrally connected to each other as one entity.

4. The wedge of claim 1. with all of the surfaces of the said wedge and coupling coated with a material to give them retention and durability characteristics.
